(19) United States
(12) Patent Application Publication
(10) Pub. No.: US 2025/0393109 A1
(43) Pub. Date: Dec. 25, 2025

(54) LIGHT-EMITTING DIODE SUPPLY VOLTAGE SYSTEM

(71) Applicant: Analog Devices International Unlimited Company, Limerick (IE)

(72) Inventors: Mario Valla, Rozzano (IT); Calogero Samuel Sciame', Rozzano (IT); Mauro Ranzato, Rozzano (IT)

(21) Appl. No.: 18/924,635

(22) Filed: Oct. 23, 2024

Related U.S. Application Data
(60) Provisional application No. 63/661,734, filed on Jun. 19, 2024.

(51) Int. Cl. H05B 45/34; H05B 45/347

(52) U.S. Cl. CPC H05B 45/34; H05B 45/347

(57) ABSTRACT

A light-emitting diode (LED) supply voltage system for adjusting an LED supply voltage can include an LED supply voltage control circuit. The LED supply voltage control circuit can include a first comparator, which can be configured to compare a headroom voltage of a current-sinking LED driver, such as measured between a current-sinking LED driver node and a reference potential node, to a first threshold value and can generate a first comparator output as a result of the comparison. The LED supply voltage system can also include an LED supply voltage control circuit, which can include comparator processing circuitry, which can be configured to receive the first comparator output and generate a feedback signal to a power converter based on the received first comparator output. This can include to recurrently, adjust the feedback signal such that the power converter reduces the LED supply voltage by a specified voltage decrement value when the first comparator output indicates that the headroom voltage can be above the first threshold value.

### CLAIM OF PRIORITY

This patent application claims the benefit of priority of Valla et al., U.S. Provisional Patent Application Ser. No. 63/661,734, entitled “POWER SAVER CONTROL FOR LOCAL DIMMING DISPLAY APPLICATIONS,” filed on Jun. 19, 2024 (Attorney Docket No. 3867.C60PRV), which is hereby incorporated by reference herein in its entirety.

### TECHNICAL FIELD

The present disclosure relates to systems including light-emitting diodes (LEDs), and more particularly, but not by way of limitation, to a system for adjusting the supply voltage of one or more LEDs.

### BACKGROUND

Light-emitting diodes (LEDs) can be semiconductor devices that can convert electrical energy into light through electroluminescence. LEDs can have various applications across different industries, such as due to one or more of efficiency, longevity, or versatility.

LEDs can be used in lighting, such as by replacing incandescent and fluorescent bulbs in homes, offices, and public spaces. They can also be used in street lighting, traffic signals, and architectural lighting.

In the electronics industry, LEDs can serve as indicator lights, backlighting for LCD screens, and as the primary light source in LED televisions.

The automotive industry can adopt LED technology in vehicle lighting systems, including headlights, taillights, brake lights, and turn signals. LEDs can also be used in automotive dashboard displays and infotainment screens, potentially providing information such as speed, fuel levels, and navigation data.

Other applications of LEDs can include horticulture for indoor farming operations and in medical fields for phototherapy treatments and spectroscopy and other diagnostic tools.

### SUMMARY

In an example, a light-emitting diode (LED) supply voltage system for adjusting an LED supply voltage can include an LED supply voltage control circuit. The LED supply voltage control circuit can include a first comparator, which can be configured to compare a headroom voltage of a current-sinking LED driver, such as measured between a current-sinking LED driver node and a reference potential node, to a first threshold value and can generate a first comparator output as a result of the comparison. The LED supply voltage system can also include an LED supply voltage control circuit, which can include comparator processing circuitry, which can be configured to receive the first comparator output and generate a feedback signal to a power converter based on the received first comparator output. This can include to recurrently, adjust the feedback signal such that the power converter reduces the LED supply voltage by a specified voltage decrement value when the first comparator output indicates that the headroom voltage can be above the first threshold value.

In an example, a method for adjusting a light-emitting diode (LED) supply voltage can include comparing a headroom voltage of a current-sinking LED driver, such as can be measured between a current-sinking LED driver node and a reference potential node, to a first threshold value. The method can also include recurrently, adjusting a feedback signal to a power converter to reduce the LED supply voltage by a specified voltage decrement value when the comparison indicates that the headroom voltage can be above the first threshold value.

In an example, a light-emitting diode (LED) supply voltage system for adjusting an LED supply voltage can include an LED supply voltage control circuit. The LED supply voltage control circuit can be configured to drive a plurality of LEDs, where each of the LEDs can be coupled to a respective current-sinking LED driver node. The LED supply voltage control circuit can include a first comparator, which can be configured to compare a headroom voltage of the respective one of the current-sinking LED driver nodes, such as can be measured between a current-sinking LED driver node and a reference potential node, to a first threshold value and can generate a respective first comparator output as a result of the comparison. The LED supply voltage system can also include comparator processing circuitry, which can be configured to receive the respective first comparator outputs and generate a feedback signal to a power converter based on the received respective first comparator outputs, such as including to recurrently, adjust the feedback signal such that the power converter reduces the LED supply voltage by a specified voltage decrement value when each of the respective first comparator outputs indicate that the headroom voltage can be above the first threshold value.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows an example of portions of an LED supply voltage system.

FIG. 2 shows an example of portions of an LED supply voltage system.

FIG. 3 shows an example of portions of an LED supply voltage system.

FIG. 4 shows an example of portions of an LED supply voltage system.

FIG. 5 shows an example of portions of a method for operating an LED supply voltage system.

FIG. 6 is a block diagram of an example of portions of a machine upon which one or more portions of the present disclosure may be implemented.

### DETAILED DESCRIPTION

A system may use one or more LEDs (e.g., an illumination system, a display system). A voltage across an LED can vary, such as corresponding to a specified illumination level (e.g., increasing a voltage across an LED can increase an illumination level). An LED can be coupled between an LED supply voltage and a reference potential (e.g., ground). The system can include an LED driver, such as can be configured to control a voltage across the LED, a current through the LED (e.g., a current sinking driver, a current sourcing driver), or both. In an example, the LED driver can be coupled between the LED and the LED supply voltage, the reference potential, or both.

The present inventors have recognized, among other things, that when the LED supply voltage is greater than the voltage across the LED (e.g., greater than, greater than a specific margin), an undesirable level of energy can be used that does not result in illumination. For example, the LED driver may dissipate the energy that is not needed (e.g., increasing the voltage across the LED driver may increase an energy dissipation in the LED driver). Accordingly, it may be desirable to adjust (e.g., reduce) the LED supply voltage to adjust (e.g., reduce) the “headroom” voltage of the LED. The headroom voltage of the LED can correspond to a voltage between the low side terminal of the LED and the reference potential, such as in the case of a current-sinking LED driver. The headroom voltage of an LED can correspond to a voltage between the high side terminal of the LED and the reference potential, such as in the case of a current-sourcing LED driver. Adjusting the LED supply voltage can help increase an efficiency of the LED supply voltage system, reduce an energy consumption of the LED supply voltage system, or both.

The present inventors have also recognized, among other things, that an LED supply voltage may be shared between two or more LEDs. This can make it desirable to monitor a headroom voltage of two or more LEDs, and adjust the LED supply voltage based on the respective headroom voltages.

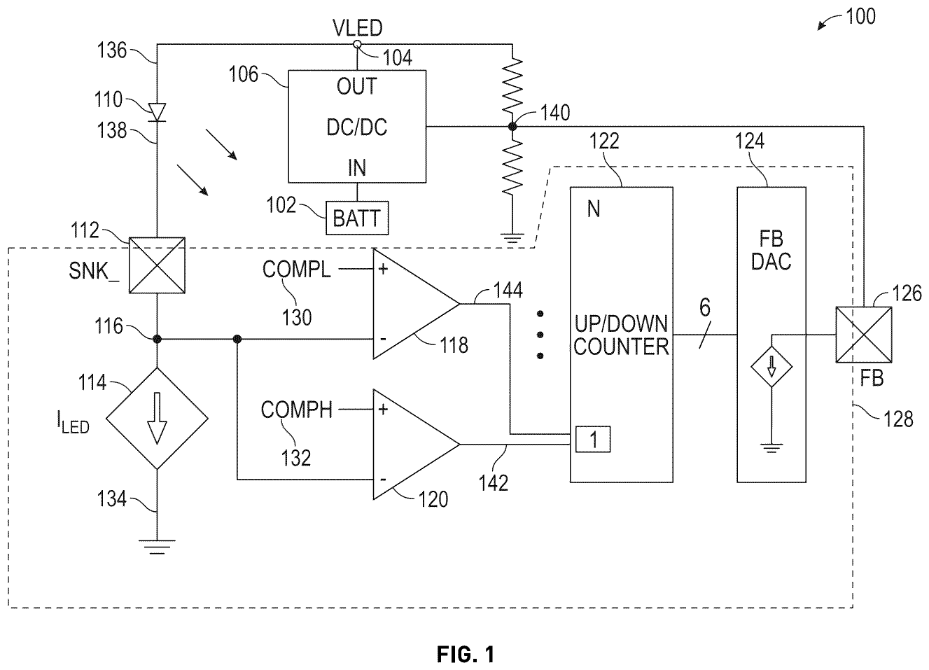

FIG. 1 shows an example of portions of an LED supply voltage system 100. The LED supply voltage system 100 can be configured for adjusting an LED supply voltage of an LED 100. The LED supply voltage system 100 can include a power source 102, a power converter 106, and an LED supply voltage control circuit 128.

The power source 102 can be any source of power, which can include one or more of an energy storage device (e.g., a battery), an energy generation device, or a connection to a power system (e.g., a connection to an electrical distribution grid, such as an electrical outlet). In an example, the power source 102 can include one or more batteries in an automobile system, such as an electric vehicle system.

The power converter 106 can be coupled to the power source 102. The power converter 106 can generate a configurable output (e.g., configurable voltage) on the supply voltage node 104. For example, the LED can convert a voltage of the power source 102 to a specified voltage on the supply voltage node 104. In an example, the power converter 106 can include a direct-current-to-direct-current converter. The power converter 106 can receive a feedback signal, such as on the feedback input node 140. The feedback signal can adjust the voltage on the supply voltage node 104, which can include one or more of increasing or decreasing the LED supply voltage. The feedback signal can include any form of signal. For example, the feedback signal can one or more of correspond to a specified output voltage, correspond to a specified ratio of the power source 102 voltage being output, or be a relative signal such that a change in the feedback signal results in a change in the output voltage (e.g., a change of a specified or unspecified magnitude).

The LED 110 can include any construction or configuration. In an example, the LED 110 can include two or more LEDs in series, parallel, or combinations thereof. In an example, the LED 110 can be replaced by any light-emitting component. The LED 110 can include a high side terminal 136 and a low side terminal 138. The high side terminal 136 can be coupled to the supply voltage node 104. The low side terminal 138 can be coupled to a current-sinking LED driver node 112 of the LED supply voltage control circuit 128.

The LED supply voltage control circuit 128 can be configured to generate a feedback signal on the feedback output node 126, such as to adjust the voltage generated on the supply voltage node 104 by the power converter 106. The LED supply voltage control circuit 128 can be configured for monitoring one or more voltages, which can include a headroom voltage, such as of the LED 110. The LED supply voltage control circuit 128 can include a current-sinking LED driver node 112, a headroom voltage node 116, current controller 114, a second comparator 118, a first comparator 120, comparator processing circuitry 122, feedback circuitry 124, and a feedback output node 126.

The current-sinking LED driver node 112 can be configured to be coupled to the low side terminal 138. The current controller 114 can be coupled between the current-sinking LED driver node 112 and the reference potential node 134 (e.g., a ground node). The current controller 114 can be configured to control a current through the LED 110. For example, the current controller 114 can adjust a voltage across the current controller 114 such as to provide a specified current value through the current controller 114.

The headroom voltage node 116 can represent a voltage between the current-sinking LED driver node 112 and the high side terminal of the current controller 114, which can include the voltage on the current-sinking LED driver node 112. The voltage on the headroom voltage node 116 can represent a headroom voltage of the LED 110. For example, if the voltage on the headroom voltage node 116 is below a specified threshold (e.g., zero, a minimum voltage value for the current controller 114 to function) the LED 110 may not be able to provide a specified illumination level. If the voltage on the headroom voltage node 116 is above the specified threshold, an energy dissipation of the LED supply voltage control circuit 128 (e.g., the current controller 114) can be larger than may be necessary to provide a specified illumination level.

The first comparator 120 can be configured to compare the headroom voltage (e.g., carried on the headroom voltage node 116) of the LED supply voltage control circuit 128 (e.g., a current-sinking LED driver) to a first threshold value 132. The headroom voltage can be measured between the current-sinking LED driver node 112 and a reference potential node 134. The first comparator 120 can generate a first comparator output as a result of the comparison. The first threshold value 132 can include a specified voltage value, such as can correspond to a headroom voltage that may affect the performance of the LED 110, or a voltage exceeding a headroom voltage that may affect the performance of the LED 110 by a specified amount (e.g., a safety factor). The first comparator 120 can generate a first comparator output 142 corresponding to a result of the comparison.

The comparator processing circuitry 122 can be configured to receive the first comparator output 142. The comparator processing circuitry 122 can generate a feedback signal (e.g., carried by the feedback output node 126), such as to the power converter 106. The feedback signal can be based on the received first comparator output. The comparator processing circuitry 122 can be configured to adjust the feedback signal such that the power converter 106 reduces the LED supply voltage by a specified voltage decrement value when the first comparator output 142 indicates that the headroom voltage is above the first threshold value. This adjustment can be performed recurrently (e.g., periodically). For example, the comparator processing circuitry 122 can adjust the feedback signal after a specified integer number of LED refresh cycles (e.g., each refresh of an LED screen can be a refresh cycle, an LED screen operating at 60 Hz can undergo 60 LED refresh cycles in one second). In an example, the specified integer number of LED refresh cycles can include between 8 and 64 LED refresh cycles. In an example, the comparator processing circuitry 122 can include an up-down counter, configured to one or more of increase, decrease, or hold a value based on one or more inputs.

The feedback circuitry 124 can be configured to receive a signal from the comparator processing circuitry 122 and generate the feedback signal on the feedback output node 126. In an example, the feedback circuitry 124 can be omitted, be included in the comparator processing circuitry 122, or both. In an example, the feedback circuitry 124 can include a feedback digital-to-analog converter (DAC), configured to receive the output of the comparator processing circuitry and generate the feedback signal. In an example in which the comparator processing circuitry 122 is an up-down counter and the feedback circuitry 124 is a DAC, the comparator processing circuitry 122 can adjust a value (e.g., a digital value) based on the received inputs. The DAC can convert this value to an analog feedback signal, such as to the power converter 106. For example, the comparator processing circuitry 122 can execute after the specified number of LED refresh cycles, and adjust the feedback signal (e.g., decrease) based on the first comparator output 142.

The second comparator 118 can be configured to compare the headroom voltage to a second threshold value 130. The second comparator 118 can generate a second comparator output 144 as a result of the comparison. The second threshold value 130 can be a specified voltage value, such as can correspond to a headroom voltage that may affect the performance of the LED 110, or a voltage exceeding a headroom voltage that may affect the performance of the LED 110 by a specified amount (e.g., a safety factor). In an example, the second threshold value 130 is smaller than the first threshold value 132. For example, the safety factor value of the first threshold value 132 can be greater than the safety factor value of the second threshold value 130.

The comparator processing circuitry 122 can be configured to receive the second comparator output 144, alternatively or in addition to the first comparator output 142. The comparator processing circuitry 122 can generate the feedback signal to the power converter 106 based on the received first comparator output 142, the received second comparator output 144, or both. The comparator processing circuitry 122 can be configured to adjust the feedback signal such that the power converter 106 increases the LED supply voltage by a specified voltage increment value when the second comparator output 144 indicates that the headroom voltage is below the second threshold value 130. This adjustment can be performed recurrently (e.g., periodically). For example, the comparator processing circuitry 122 can adjust the feedback signal after a specified integer number of LED refresh cycles. In an example, the specified integer number of LED refresh cycles can include between 1 and 64 LED refresh cycles.

In an example, the specified voltage increment value can be greater than the specified voltage decrement value. For example, the specified voltage increment value can be twice as large, three times as large, four times as large, or five or more times as large as the specified voltage decrement value.

In an example, a frequency of increasing the LED supply voltage by the specified voltage increment value (e.g., checking whether the second comparator output 144 indicates that the headroom voltage is below the second threshold value 130) for a potential increase) can be greater than a frequency of decreasing the LED supply voltage by the specified voltage decrement value (e.g., checking whether the first comparator output 142 indicates that the headroom voltage is above the first threshold value 132). For example, the LED supply voltage control circuit 128 can be configured to recurrently reduce the LED supply voltage while the headroom voltage is above the first threshold value 132. The LED supply voltage control circuit 128 can wait for a period of time (e.g., a number of LED refresh cycles) before decreasing the LED supply voltage so that the system has time to stabilize (e.g., so that the headroom voltage stabilizes). The LED supply voltage control circuit 128 can be configured to recurrently raise the LED supply voltage while the headroom voltage is below the second threshold value 130. The LED supply voltage control circuit 128 can use a specified voltage increment value that is greater than the specified voltage decrement value, a frequency of increasing the voltage that is greater than a frequency of decreasing the voltage, or both, such as because the LED 110 may not be operating as desired when a voltage increase is warranted.

In an example, because the second threshold value 130 may be below the first threshold value 132, the LED supply voltage control circuit 128 may only be increasing or decreasing the voltage at a specified time, rather than both increasing by the specified voltage increment value and decreasing by the specified voltage decrement value.

In an example, an LED supply voltage value that produces a specified headroom voltage changes due to an illumination level of an LED screen utilizing the LED supply voltage. For example, an LED screen can include one or more LEDs (e.g., backlight LEDs, pixel LEDs), and an illumination level of these LEDs can affect an illumination level of the screen. In an example, when an illumination level of the screen is reduced, the LED supply voltage can be reduced. By monitoring the headroom voltage under a specified operating condition directly, as opposed to using an estimated and/or simulated value for the specified operating condition, the LED supply voltage control circuit 128 may be able to tailor the LED supply voltage such as to decrease a power consumption of the LED supply voltage system 100, such as while maintaining proper function of the LED 110.

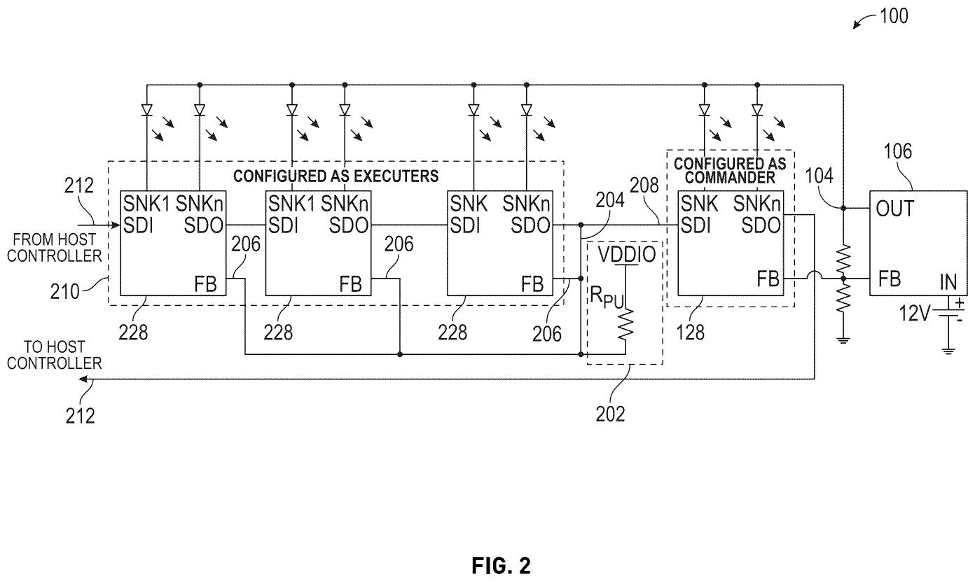

FIG. 2 shows an example of portions of an LED supply voltage system 100. The LED supply voltage system 100 of FIG. 2 can be configured similarly to the LED supply voltage system 100 of FIG. 1, or can differ in one or more ways. FIG. 2 shows that the LED supply voltage system 100 can include a bank 210 of one or more additional LED supply voltage control circuits 228. These LED supply voltage control circuits 228 can be configured similarly to the LED supply voltage control circuit 128 of FIG. 1, or can differ in one or more ways. FIG. 2 shows that the LED supply voltage control circuits 228 can be configured as executers, and the LED supply voltage control circuit 128 can be configured as a commander.

The LED supply voltage control circuits 228 can be configured to drive LEDs, such as using the LED supply voltage. Respective ones of the LED supply voltage control circuits 228 can include a first comparator. The first comparator can be configured to compare a headroom voltage of the current-sinking LED driver to the first threshold value and generate a first comparator output as a result of the comparison. The respective ones of the LED supply voltage control circuits 228 can also include comparator processing circuitry 122. The comparator processing circuitry 122 can be configured to receive the first comparator output and generate a feedback signal to the LED supply voltage control circuit 128. The feedback signal to the LED supply voltage control circuit 128 can indicate when the first comparator indicates that the headroom voltage is above the first threshold value.

Following receiving the signal that the headroom voltage is greater than the first threshold value, the comparator processing circuitry 122 of the LED supply voltage control circuit 128 can adjust the feedback signal such that the power converter 106 decreases the LED supply voltage by the specified voltage decrement value. In an example, all of the LED supply voltage control circuits 228 and the LED supply voltage control circuit 128 must determine that the respective headroom voltages are greater than the first threshold value for the LED supply voltage control circuit 128 to decrease the LED supply voltage.

Respective ones of the LED supply voltage control circuits 228 can include a second comparator. The second comparator can be configured to compare a headroom voltage of a current-sinking LED driver to the second threshold value and generate a second comparator output as a result of the comparison. The comparator processing circuitry 122 can be configured to receive the second comparator output and generate a feedback signal to the LED supply voltage control circuit 128. The feedback signal to the LED supply voltage control circuit 128 can indicate when the second comparator indicates that the headroom voltage is below the second threshold value.

Following receiving the signal that the headroom voltage is less than the second threshold value, the comparator processing circuitry 122 of the LED supply voltage control circuit 128 can adjust the feedback signal such that the power converter 106 increases the LED supply voltage by the specified voltage increment value. In an example, only one of the LEDs in the LED supply voltage system 100 must have a headroom voltage that is below the second threshold value for the LED supply voltage control circuit 128 to increase the LED supply voltage.

The LED supply voltage control circuit 128 can include an input pin 208 to receive a digital signal from the one or more additional LED supply voltage control circuits 228. Respective ones of the LED supply voltage control circuits 228 can include an output pin 206 to signal the LED supply voltage control circuit. In an example, the input pin 208 can be shared by two or more of the LED supply voltage control circuits 228. The input pin 208 can have a specified input impedance, which can include a large input impedance (e.g., over 100 kiloohms, over 1 megaohm). This can allow the input pin 208 to monitor a voltage on the shared signaling node 204 without substantially affecting the voltage on the shared signaling node 204.

One or more of the output pins 206 and the input pin 208 can be coupled together at a shared signaling node 204. The respective output pins 206 can be normally in an unconnected state (e.g., open state, a state that does not affect the voltage on the output pin 206 and/or allow a current to flow through the output pin 206) and can be grounded when connected (e.g., coupled to ground, pulling a voltage on the output pin 206 to or towards zero, allowing a current flowing through the output pin 206 to ground).

The LED supply voltage system can include a pull-up circuit 202 which can be configured to pull the voltage of the signaling node up to a specified value, such as when all of the output pins are unconnected (e.g., the pull-up circuit 202 pulls the voltage on the shared signaling node 204 up to the specified value when none of the output pins 206 are pulling the voltage to the ground potential). For example, the LED supply voltage control circuit 128 can determine that all of the respective second comparators of the LED supply voltage control circuits 228 are indicating that the headroom voltage is above the second threshold value when the voltage on the shared signaling node 204 is a logical high value (e.g., the voltage on the shared signaling node 204 is at or near the specified value). When the voltage on the shared signaling node 204 is a logical low value (e.g., at or near the reference potential), the LED supply voltage control circuit 128 can determine that one or more of the respective second comparators of the LED supply voltage control circuits 228 are indicating that the headroom voltage is below the second threshold value.

FIG. 2 shows that the LED supply voltage system 100 can also include a communication link 212, such as to a host microcontroller or other system. The communication link 212 can include a digital communication system, such as a serial communication line. One or more of the LED supply voltage control circuits 228 or the LED supply voltage control circuit 128 can be daisy chained, as shown in FIG. 2. The LED supply voltage control circuit 128 can use the communication link input pin as the input pin 208. For example, communication over the communication link 212 may not be continuous, and the LED supply voltage control circuit 128 can use the input pin 208 to receive signals from the LED supply voltage control circuits 228 when not in use for other communications.

FIG. 2 shows an example with three LED supply voltage control circuits 228, but any number of executer LED supply voltage control circuits 228 can be used (e.g., one, two, three, four, five or more).

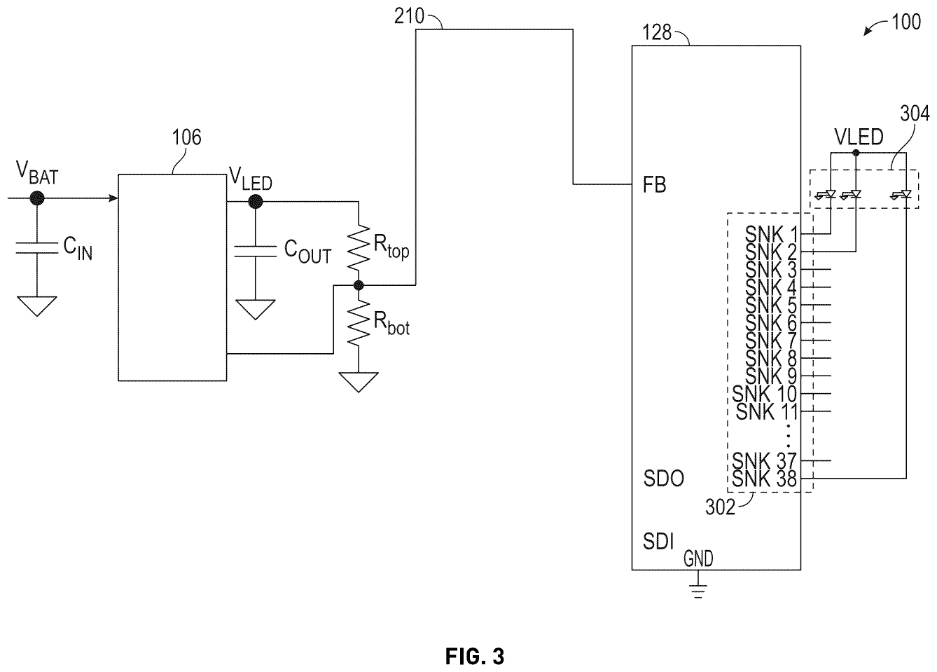

FIG. 3 shows an example of portions of an LED supply voltage system 100. The LED supply voltage system 100 of FIG. 3 can be configured similarly to the LED supply voltage system 100 of FIG. 1, or can differ in one or more ways. In the example of FIG. 3, the LED supply voltage control circuit 128 can be configured to drive a plurality of LEDs 304. The LED supply voltage control circuit 128 can include a plurality of current-sinking LED driver nodes 302. Each of the LEDs can be coupled to a respective current-sinking LED driver node.

FIG. 3 shows that respective individual ones of the respective plurality of current-sinking LED driver nodes 302 can be coupled to respective individual ones of a plurality of LEDs 304. In the example of FIG. 3, 38 LEDs coupled to corresponding ones of 38 current-sinking LED driver nodes are shown, but any number of LEDs and current-sinking LED driver nodes can be used.

The LED supply voltage control circuit 128 can provide a plurality of current-sinking LED driver nodes which can be configured to be coupled to a low side terminal of respective ones of the plurality of LEDs. A high side terminal of the respective ones of the plurality of LEDs can be coupled to the LED supply voltage.

In an example, one or more (e.g., each) of the respective current-sinking LED driver nodes 302 can be configured similarly to the current-sinking LED driver node 112, or may differ in one or more ways. For example, one or more (e.g., each) of the respective current-sinking LED driver nodes 302 can include a first comparator, such as can be configured to compare a headroom voltage of the respective one of the current-sinking LED driver nodes, which can be measured between the respective current-sinking LED driver node and a reference potential node, to the first threshold value. The respective first comparator can generate a respective first comparator output as a result of the comparison.

One or more of the respective current-sinking LED driver nodes 302 can include a second comparator, such as can be configured to compare the headroom voltage of the respective one of the current-sinking LED driver nodes to the second threshold value. The respective second comparator can generate a respective second comparator output as a result of the comparison.

In an example, the comparator processing circuitry 122 of the LED supply voltage control circuit 128 can be configured to receive one or more of the respective first comparator outputs, the respective second comparator outputs, or both. The comparator processing circuitry 122 can generate a feedback signal to the power converter 106, such as based on the received respective first comparator outputs and respective second comparator outputs.

The comparator processing circuitry 122 can be configured to adjust the feedback signal such that the power converter reduces the LED supply voltage by the specified voltage decrement value, such as when each of the respective first comparator outputs indicate that the headroom voltage is above the first threshold value. This adjustment can be performed recurrently.

In an example, the comparator processing circuitry 122 of the LED supply voltage control circuit 128 can be configured to adjust the feedback signal such that the power converter increases the LED supply voltage by the specified voltage increment value, such as when at least one of the respective second comparator outputs indicates that the headroom voltage is below the second threshold value.

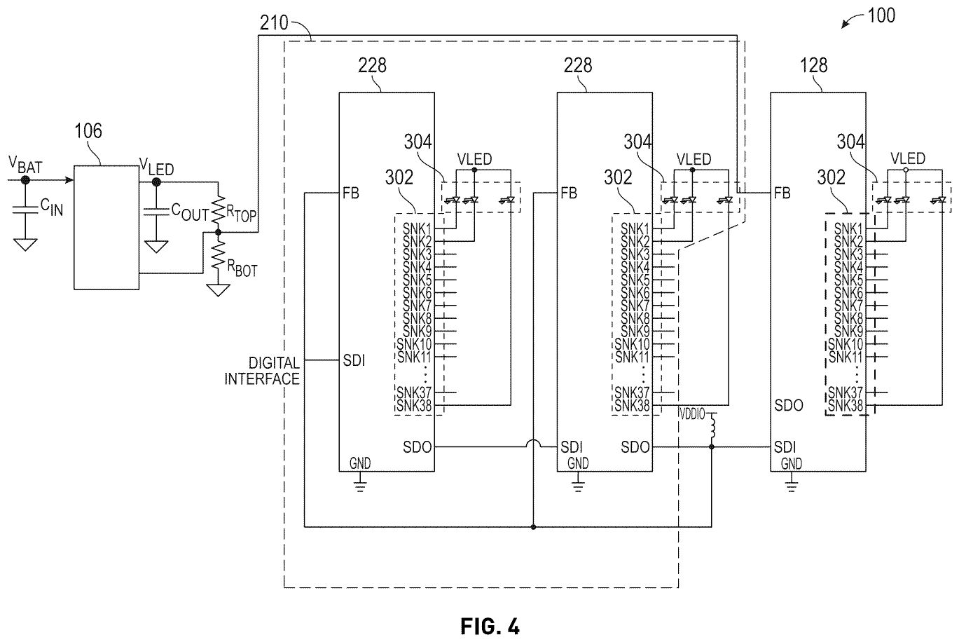

FIG. 4 shows an example of portions of an LED supply voltage system 100. The LED supply voltage system 100 of FIG. 4 can be configured similarly to the LED supply voltage system 100 of FIG. 2 and/or FIG. 3, or can differ in one or more ways. FIG. 4 shows that one or more of the LED supply voltage control circuits 228 or the LED supply voltage control circuit 128 can include a plurality of current-sinking LED driver nodes 302. The LED supply voltage system 100, and one or more of the LED supply voltage control circuits 228 or the LED supply voltage control circuit 128 can configured to drive a plurality of LEDs 304. One or more (e.g., each) of the LEDs 304 can be coupled to a respective current-sinking LED driver node.

In an example where the LED supply voltage system 100 includes an LED supply voltage control circuit 128 in addition to one or more additional LED supply voltage control circuits 228, one or more of the current-sinking nodes of the one or more additional LED supply voltage control circuits 228 can be configured similarly to the current-sinking LED driver node 112 (e.g., similarly to the configuration of the LED supply voltage control circuit 128 discussed above). In this example, the LED supply voltage control circuits 228 may signal to the LED supply voltage control circuit 128 that the headroom voltage is above the first threshold value when one or more (e.g., all) of the respective first comparators in the respective LED supply voltage control circuit 228 indicate that the headroom voltage is above the first threshold value. This may result in the LED supply voltage control circuit 128 signaling the power converter 106 to decrease the LED supply voltage only when all of the LEDs controlled by the LED supply voltage system 100 (e.g., all of the plurality of LEDs 304) have a headroom voltage above the first threshold value.

The LED supply voltage control circuits 228 may signal to the LED supply voltage control circuit 128 when one or more of the respective first comparators in the respective LED supply voltage control circuit 228 indicate that the headroom voltage is below the second threshold value. This may result in the LED supply voltage control circuit 128 signaling the power converter 106 to increase the LED supply voltage when a single one (e.g., or more) of the LEDs controlled by the LED supply voltage system 100 (e.g., all of the plurality of LEDs 304) have a headroom voltage that is below the second threshold value.

In an example, each of the LED supply voltage control circuit 128 and the one or more additional LED supply voltage control circuits 228 can provide a plurality of current-sinking LED driver nodes configured to be coupled to a low side terminal of a plurality of LEDs, wherein a high side terminal of the plurality of LEDs are coupled to the LED supply voltage.

This disclosure is believed to apply, at least in part, to current-sourcing LED drivers in addition to current-sinking LED drivers. In the example of a current-sourcing LED driver, the LED 110 may be coupled to ground on the low side terminal 138 and to a current-sourcing node on the high side terminal 136. In this example, the headroom can be measured between the LED supply voltage and the voltage on the current-sourcing node. The rest of the circuitry may perform similar or the same operations as discussed above (e.g., comparing the headroom voltage to thresholds, adjusting the LED supply voltage).

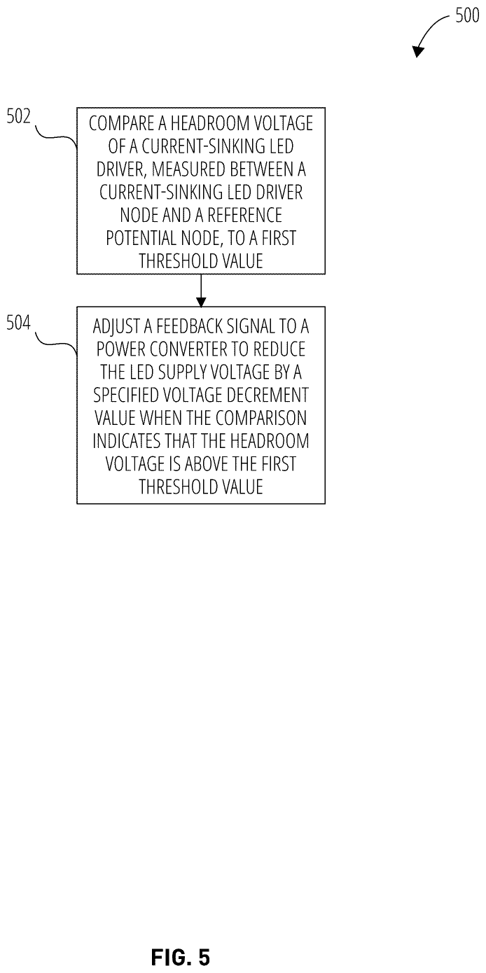

FIG. 5 shows an example of portions of a method 500 for operating an LED supply voltage system, such as the LED supply voltage system 100. The method 500 can include a method for adjusting an LED supply voltage. At step 502, a headroom voltage of a current-sinking LED driver, measured between a current-sinking LED driver node and a reference potential node, can be compared to a first threshold value. This can include comparing the voltage on the headroom voltage node 116 to the first threshold value 132.

At step 504, a feedback signal to a power converter can be adjusted, such as to reduce the LED supply voltage by a specified voltage decrement value, such as when the comparison indicates that the headroom voltage is above the first threshold value. In an example, step 504 can be performed more than once, such as recurrently.

Alternatively or in addition, the method 500 can include comparing the headroom voltage of the current-sinking LED driver to a second threshold value. The method can also include adjusting the feedback signal to the power converter, such as to increase the LED supply voltage by a specified voltage increment value, such as when the comparison indicates that the headroom voltage is below the second threshold value. In an example, this comparison and adjustment can be performed more than once, such as recurrently. In an example, the second threshold value is smaller than the first threshold value.

The shown order of steps is not intended to be a limitation on the order in which the steps are performed. In an example, two or more steps may be performed simultaneously or at least partially concurrently.

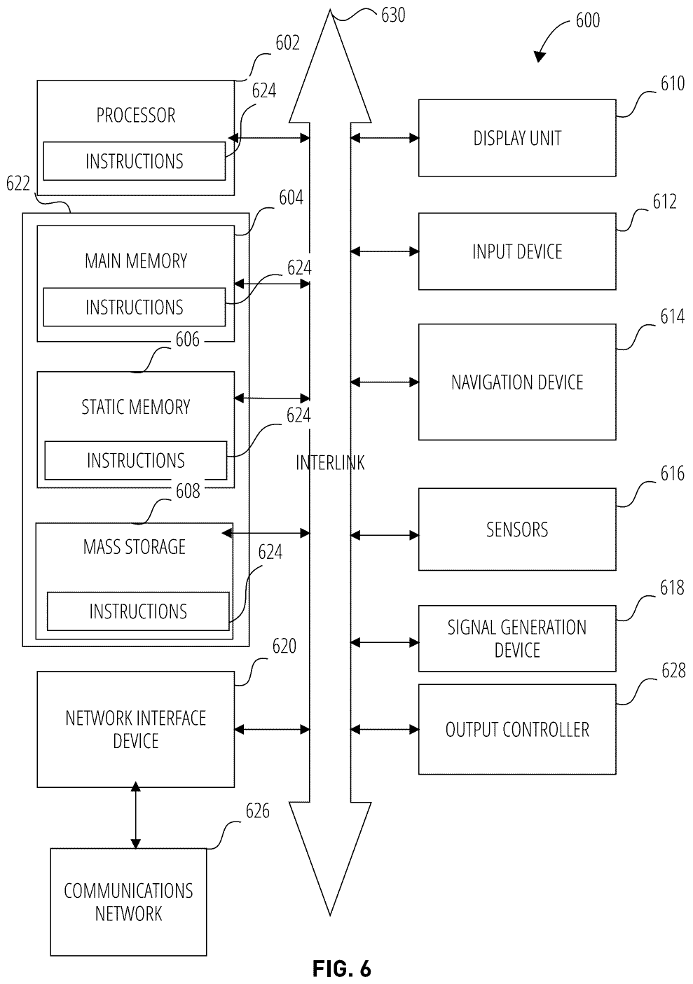

FIG. 6 illustrates a block diagram of an example machine 600 upon which any one or more of the techniques (e.g., methodologies) discussed herein may be implemented. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), and mass storage 608 (e.g., hard drives, tape drives, flash storage, or other block devices) some or all of which may communicate with each other via an interlink 630 (e.g., bus). The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 622 may be representative of the instructions 624, such as instructions 624 themselves or a format from which the instructions 624 may be derived. This format from which the instructions 624 may be derived may include source code, encoded instructions (e.g., in compressed or encrypted form), packaged instructions (e.g., split into multiple packages), or the like. The information representative of the instructions 624 in the machine readable medium 622 may be processed by processing circuitry into the instructions to implement any of the operations discussed herein. For example, deriving the instructions 624 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 may include assembly, compilation, or interpretation of the information (e.g., by the processing circuitry) to create the instructions 624 from some intermediate or preprocessed format provided by the machine readable medium 622. The information, when provided in multiple parts, may be combined, unpacked, and modified to create the instructions 624. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine-readable medium.

The following, non-limiting examples, detail certain aspects of the present subject matter to solve the challenges and provide the benefits discussed herein, among others.

### EXAMPLES

In Example 1, the subject matter of Example undefined optionally includes, wherein: recurrently adjusting the feedback signal includes adjusting the feedback signal after a specified integer number of LED refresh cycles.

In Example 2, the subject matter of Example undefined optionally includes, comprising: a second comparator configured to compare the headroom voltage of the current-sinking LED driver to a second threshold value and generate a second comparator output as a result of the comparison; and wherein the comparator processing circuitry is configured to receive the first comparator output and the second comparator output and generate a feedback signal to a power converter based on the received first comparator output and second comparator output, including to: recurrently, adjust the feedback signal such that the power converter increases the LED supply voltage by a specified voltage increment value when the second comparator output indicates that the headroom voltage is below the second threshold value, wherein the second threshold value is smaller than the first threshold value.

In Example 3, the subject matter of Example 2 optionally includes wherein the specified voltage increment value is greater than the specified voltage decrement value.

In Example 4, the subject matter of any one or more of Examples 2-3 optionally include wherein a frequency of increasing the LED supply voltage by the specified voltage increment value is greater than a frequency of decreasing the LED supply voltage by the specified voltage decrement value.

In Example 5, the subject matter of any one or more of Examples 2-4 optionally include wherein; the LED supply voltage control circuit is configured to drive a plurality of LEDs; each of the LEDs are coupled to a respective current-sinking LED driver node; each of the respective current-sinking LED driver nodes include: a first comparator configured to compare a headroom voltage of the respective one of the current-sinking LED driver nodes, measured between the respective current-sinking LED driver node and a reference potential node, to the first threshold value and generate a respective first comparator output as a result of the comparison; and a second comparator configured to compare the headroom voltage of the respective one of the current-sinking LED driver nodes to a second threshold value and generate a respective second comparator output as a result of the comparison; and the comparator processing circuitry is configured to receive the respective first comparator outputs and the respective second comparator outputs and generate a feedback signal to a power converter based on the received respective first comparator outputs and respective second comparator outputs, including to: recurrently, adjust the feedback signal such that the power converter reduces the LED supply voltage by the specified voltage decrement value when each of the respective first comparator outputs indicate that the headroom voltage is above the first threshold value.

In Example 6, the subject matter of Example 5 optionally includes wherein the comparator processing circuitry is configured to: recurrently, adjust the feedback signal such that the power converter increases the LED supply voltage by the specified voltage increment value when at least one of the respective second comparator outputs indicates that the headroom voltage is below the second threshold value.

In Example 7, the subject matter of any one or more of Examples 4-6 optionally include wherein: the LED supply voltage control circuit provides a plurality of current-sinking LED driver nodes configured to be coupled to a low side terminal of respective ones of a plurality of LEDs, wherein a high side terminal of the respective ones of the plurality of LEDs are coupled to the LED supply voltage.

In Example 8, the subject matter of any one or more of Examples 2-7 optionally include one or more additional LED supply voltage control circuits, wherein the one or more additional LED supply voltage control circuits are configured to drive LEDs using the LED supply voltage, wherein respective ones of the one or more additional LED supply voltage control circuits comprise: a comparator configured to compare a headroom voltage of a current-sinking LED driver to the second threshold value and generate a first comparator output as a result of the comparison; and comparator processing circuitry, configured to receive the first comparator output and generate a feedback signal to the LED supply voltage control circuit, including to: signal to the LED supply voltage control circuit when the first comparator indicates that the headroom voltage is below the second threshold value.

In Example 9, the subject matter of Example 8 optionally includes wherein: following receiving the signal that the headroom voltage is less than the second threshold value, the comparator processing circuitry of the LED supply voltage control circuit adjusts the feedback signal such that the power converter increases the LED supply voltage by the specified voltage increment value.

In Example 10, the subject matter of any one or more of Examples 8-9 optionally include wherein: the LED supply voltage control circuit includes an input pin to receive a digital signal from the one or more additional LED supply voltage control circuits; and the one or more additional LED supply voltage control circuits include an output pin to signal the LED supply voltage control circuit.

In Example 11, the subject matter of Example 10 optionally includes wherein the input pin is shared by two or more of the one or more additional LED supply voltage control circuits.

In Example 12, the subject matter of Example 11 optionally includes wherein; the respective output pins and the input pin are coupled together at a shared signaling node; the respective output pins are normally in an unconnected state and grounded when connected; and the LED supply voltage system comprises a pull-up circuit configured to pull the voltage of the signaling node up to a specified value when all of the output pins are unconnected.

In Example 13, the subject matter of any one or more of Examples 8-12 optionally include wherein: each of the LED supply voltage control circuit and the one or more additional LED supply voltage control circuits provide a plurality of current-sinking LED driver nodes configured to be coupled to a low side terminal of a plurality of LEDs, wherein a high side terminal of the plurality of LEDs are coupled to the LED supply voltage.

In Example 14, the subject matter of Example undefined optionally includes, wherein an LED supply voltage value that produces a specified headroom voltage changes due to an illumination level of an LED screen utilizing the LED supply voltage.

In Example 15, the subject matter of Example undefined optionally includes, comprising a feedback digital-to-analog converter (DAC), configured to receive the output of the comparator processing circuitry and generate the feedback signal.

In Example 16, the subject matter of Example undefined optionally includes, further comprising the power converter.

Example 17 is a method for adjusting an light-emitting diode (LED) supply voltage, comprising: comparing a headroom voltage of a current-sinking LED driver, measured between a current-sinking LED driver node and a reference potential node, to a first threshold value; and recurrently, adjusting a feedback signal to a power converter to reduce the LED supply voltage by a specified voltage decrement value when the comparison indicates that the headroom voltage is above the first threshold value.

In Example 18, the subject matter of Example 17 optionally includes comparing the headroom voltage of the current-sinking LED driver to a second threshold value; and recurrently, adjusting the feedback signal to the power converter to increase the LED supply voltage by a specified voltage increment value when the comparison indicates that the headroom voltage is below the second threshold value, wherein the second threshold value is smaller than the first threshold value.

Example 19 is a light-emitting diode (LED) supply voltage system for adjusting an LED supply voltage, the LED supply voltage system comprising: an LED supply voltage control circuit configured to drive a plurality of LEDs, wherein each of the LEDs are coupled to a respective current-sinking LED driver node; including: a first comparator configured to compare a headroom voltage of the respective one of the current-sinking LED driver nodes, measured between a current-sinking LED driver node and a reference potential node, to a first threshold value and generate a respective first comparator output as a result of the comparison; and comparator processing circuitry, configured to receive the respective first comparator outputs and generate a feedback signal to a power converter based on the received respective first comparator outputs, including to: recurrently, adjust the feedback signal such that the power converter reduces the LED supply voltage by a specified voltage decrement value when each of the respective first comparator outputs indicate that the headroom voltage is above the first threshold value.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the terms “or” and “and/or” are used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A light-emitting diode (LED) supply voltage system for adjusting an LED supply voltage, the LED supply voltage system comprising:
an LED supply voltage control circuit, including:
a first comparator configured to compare a headroom voltage of a current-sinking LED driver, measured between a current-sinking LED driver node and a reference potential node, to a first threshold value and generate a first comparator output as a result of the comparison; and
comparator processing circuitry, configured to receive the first comparator output and generate a feedback signal to a power converter based on the received first comparator output, including to:
recurrently, adjust the feedback signal such that the power converter reduces the LED supply voltage by a specified voltage decrement value when the first comparator output indicates that the headroom voltage is above the first threshold value.

2. The LED supply voltage system of claim 1, wherein:
recurrently adjusting the feedback signal includes adjusting the feedback signal after a specified integer number of LED refresh cycles.

3. The LED supply voltage system of claim 1, comprising:
a second comparator configured to compare the headroom voltage of the current-sinking LED driver to a second threshold value and generate a second comparator output as a result of the comparison; and
wherein the comparator processing circuitry is configured to receive the first comparator output and the second comparator output and generate a feedback signal to a power converter based on the received first comparator output and second comparator output, including to:
recurrently, adjust the feedback signal such that the power converter increases the LED supply voltage by a specified voltage increment value when the second comparator output indicates that the headroom voltage is below the second threshold value, wherein the second threshold value is smaller than the first threshold value.

4. The LED supply voltage system of claim 3, wherein the specified voltage increment value is greater than the specified voltage decrement value.

5. The LED supply voltage system of claim 3, wherein a frequency of increasing the LED supply voltage by the specified voltage increment value is greater than a frequency of decreasing the LED supply voltage by the specified voltage decrement value.

6. The LED supply voltage system of claim 3, wherein;
the LED supply voltage control circuit is configured to drive a plurality of LEDs;
each of the LEDs are coupled to a respective current-sinking LED driver node;
each of the respective current-sinking LED driver nodes include:
a first comparator configured to compare a headroom voltage of the respective one of the current-sinking LED driver nodes, measured between the respective current-sinking LED driver node and a reference potential node, to the first threshold value and generate a respective first comparator output as a result of the comparison; and
a second comparator configured to compare the headroom voltage of the respective one of the current-sinking LED driver nodes to a second threshold value and generate a respective second comparator output as a result of the comparison; and
the comparator processing circuitry is configured to receive the respective first comparator outputs and the respective second comparator outputs and generate a feedback signal to a power converter based on the received respective first comparator outputs and respective second comparator outputs, including to:
recurrently, adjust the feedback signal such that the power converter reduces the LED supply voltage by the specified voltage decrement value when each of the respective first comparator outputs indicate that the headroom voltage is above the first threshold value.

7. The LED supply voltage system of claim 6, wherein the comparator processing circuitry is configured to:
recurrently, adjust the feedback signal such that the power converter increases the LED supply voltage by the specified voltage increment value when at least one of the respective second comparator outputs indicates that the headroom voltage is below the second threshold value.

8. The LED supply voltage system of claim 5, wherein:
the LED supply voltage control circuit provides a plurality of current-sinking LED driver nodes configured to be coupled to a low side terminal of respective ones of a plurality of LEDs, wherein a high side terminal of the respective ones of the plurality of LEDs are coupled to the LED supply voltage.

9. The LED supply voltage system of claim 3, comprising:
one or more additional LED supply voltage control circuits, wherein the one or more additional LED supply voltage control circuits are configured to drive LEDs using the LED supply voltage, wherein respective ones of the one or more additional LED supply voltage control circuits comprise:
a comparator configured to compare a headroom voltage of a current-sinking LED driver to the second threshold value and generate a first comparator output as a result of the comparison; and
comparator processing circuitry, configured to receive the first comparator output and generate a feedback signal to the LED supply voltage control circuit, including to:
signal to the LED supply voltage control circuit when the first comparator indicates that the headroom voltage is below the second threshold value.

10. The LED supply voltage system of claim 9, wherein:
following receiving the signal that the headroom voltage is less than the second threshold value, the comparator processing circuitry of the LED supply voltage control circuit adjusts the feedback signal such that the power converter increases the LED supply voltage by the specified voltage increment value.

11. The LED supply voltage system of claim 9, wherein:
the LED supply voltage control circuit includes an input pin to receive a digital signal from the one or more additional LED supply voltage control circuits; and
the one or more additional LED supply voltage control circuits include an output pin to signal the LED supply voltage control circuit.

12. The LED supply voltage system of claim 11, wherein the input pin is shared by two or more of the one or more additional LED supply voltage control circuits.

13. The LED supply voltage system of claim 12, wherein;
the respective output pins and the input pin are coupled together at a shared signaling node;
the respective output pins are normally in an unconnected state and grounded when connected; and
the LED supply voltage system comprises a pull-up circuit configured to pull the voltage of the signaling node up to a specified value when all of the output pins are unconnected.

14. The LED supply voltage system of claim 9, wherein:
each of the LED supply voltage control circuit and the one or more additional LED supply voltage control circuits provide a plurality of current-sinking LED driver nodes configured to be coupled to a low side terminal of a plurality of LEDs, wherein a high side terminal of the plurality of LEDs are coupled to the LED supply voltage.

15. The LED supply voltage system of claim 1, wherein an LED supply voltage value that produces a specified headroom voltage changes due to an illumination level of an LED screen utilizing the LED supply voltage.

16. The LED supply voltage system of claim 1, comprising a feedback digital-to-analog converter (DAC), configured to receive the output of the comparator processing circuitry and generate the feedback signal.

17. The LED supply voltage system of claim 1, further comprising the power converter.

18. A method for adjusting an light-emitting diode (LED) supply voltage, comprising:
comparing a headroom voltage of a current-sinking LED driver, measured between a current-sinking LED driver node and a reference potential node, to a first threshold value; and
recurrently, adjusting a feedback signal to a power converter to reduce the LED supply voltage by a specified voltage decrement value when the comparison indicates that the headroom voltage is above the first threshold value.

19. The method of claim 18, comprising:
comparing the headroom voltage of the current-sinking LED driver to a second threshold value; and
recurrently, adjusting the feedback signal to the power converter to increase the LED supply voltage by a specified voltage increment value when the comparison indicates that the headroom voltage is below the second threshold value, wherein the second threshold value is smaller than the first threshold value.

20. A light-emitting diode (LED) supply voltage system for adjusting an LED supply voltage, the LED supply voltage system comprising:
an LED supply voltage control circuit configured to drive a plurality of LEDs, wherein each of the LEDs are coupled to a respective current-sinking LED driver node; including:
a first comparator configured to compare a headroom voltage of the respective one of the current-sinking LED driver nodes, measured between a current-sinking LED driver node and a reference potential node, to a first threshold value and generate a respective first comparator output as a result of the comparison; and
comparator processing circuitry, configured to receive the respective first comparator outputs and generate a feedback signal to a power converter based on the received respective first comparator outputs, including to:
recurrently, adjust the feedback signal such that the power converter reduces the LED supply voltage by a specified voltage decrement value when each of the respective first comparator outputs indicate that the headroom voltage is above the first threshold value.
